(19) United States
(12) Patent Application Publication
(10) Pub. No.: US 2006/0117646 A1
(43) Pub. Date: Jun. 8, 2006

(54) Insect capturing apparatus and method of use thereof

(76) Inventor: Jian Dai, Niskayuna, NY (US)

Correspondence Address: Schmeiser, Olsen & Watts LLP;Suite 201, 3 Lear Jet Lane, Latham, NY, 12110, US

(21) Appl. No.: 11/001,835

(22) Filed: Dec. 2, 2004

(51) Int. Cl. A01M 1/06; A01M 1/02

(52) U.S. Cl. 43/139; 43/107

(57) ABSTRACT

An insect capturing apparatus includes a Stirling engine to facilitate the generation of a gaseous flow for introducing insects within a receptacle. The Stirling engine acts with an external heat source that may produce insect-attractive chemical emissions as by-products of heat generation. The insect-attractant emissions may be utilized to attract insects to the apparatus for capture within the receptacle.

### BACKGROUND OF INVENTION

1. Technical Field

This invention relates generally to capturing insects. More particularly, this invention provides for an insect capturing apparatus comprising a Stirling engine to generate airflow facilitating the capture of insects and a corresponding method of use thereof.

2. Related Art

Insects are a common nuisance. It is well known in the art that insects are drawn to various chemical attractants. In this regard, common insect capturing devices have in general supplied insect-enticing chemicals by releasing the attractants from tanks, by allowing the attractants to gradually sublimate, and/or by producing the attractants as by-products of energy conversion. Moreover, typical insect capturing devices have utilized various energy conversion components, such as fuel cells and internal combustion engines to facilitate the generation of electricity and/or mechanical movement to power fans, blowers, vacuums, oxidizers, pumps, lights and/or other device elements utilized to capture insects. However, the standard course implemented in common insect capturing devices for providing chemical attractants and/or accomplishing energy conversion is cumbersome, involving complex components with several inefficiencies.

Accordingly, there is a need for an improved insect capturing apparatus including an efficient Stirling engine operably associated with a heat source, wherein the heat source produces insect-attractive chemical emissions, and a corresponding method of capturing insects through the use of the insect capturing apparatus.

### SUMMARY OF INVENTION

The present invention is directed to an insect capturing apparatus that offers improved operability.

A first general aspect of the invention provides for an insect capturing apparatus comprising a Stirling engine, wherein the Stirling engine is configured to convert heat energy to kinetic energy for generating a gaseous flow, and a receptacle in communication with the gaseous flow, wherein the receptacle receives insects.

A second general aspect of the invention provides for an insect capturing apparatus comprising a heat source, wherein the heat source produces insect-attractive chemical emissions, and a Stirling engine, operably associated with the heat source, wherein the Stirling engine facilitates the generation of a gaseous flow to detain insects within the apparatus.

A third general aspect of the invention provides for a method for capturing insects, wherein the method comprises providing a receptacle having an inlet through which insects can enter into the receptacle, providing insect-attractive chemical emissions, the emissions produced by a heat source supplying heat energy to a Stirling engine, and mixing the insect-attractive chemical emissions with a gaseous flow generated by the Stirling engine, the gaseous flow facilitating introduction of insects within the receptacle.

The foregoing and other features of the invention will be apparent from the following more particular description of various embodiments of the invention.

### BRIEF DESCRIPTION OF THE DRAWINGS

Some of the embodiments of this invention will be described in detail, with reference to the following figures, wherein like designations denote like members, wherein:

FIG. 1 depicts a perspective view of an embodiment of an insect capturing apparatus, in accordance with the present invention;

FIG. 2 depicts a sectional view of an embodiment of an insect capturing apparatus including fan powered by a Stirling engine, in accordance with the present invention;

FIG. 3 depicts a sectional view of an embodiment of an insect capturing apparatus including an acoustic Stirling engine in a vertical position, in accordance with the present invention; and

FIG. 4 depicts a cut-away perspective view of an embodiment of an insect capturing apparatus including an acoustic Stirling engine in a horizontal position, in accordance with the present invention.

### DETAILED DESCRIPTION OF THE INVENTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of an embodiment. The features and advantages of the present invention are illustrated in detail in the accompanying drawings, wherein like reference numerals refer to like elements throughout the drawings.

As a preface to the detailed description, it should be noted that, as used in this specification and the appended claims, the singular forms “a”, “an” and “the” include plural referents, unless the context clearly dictates otherwise.

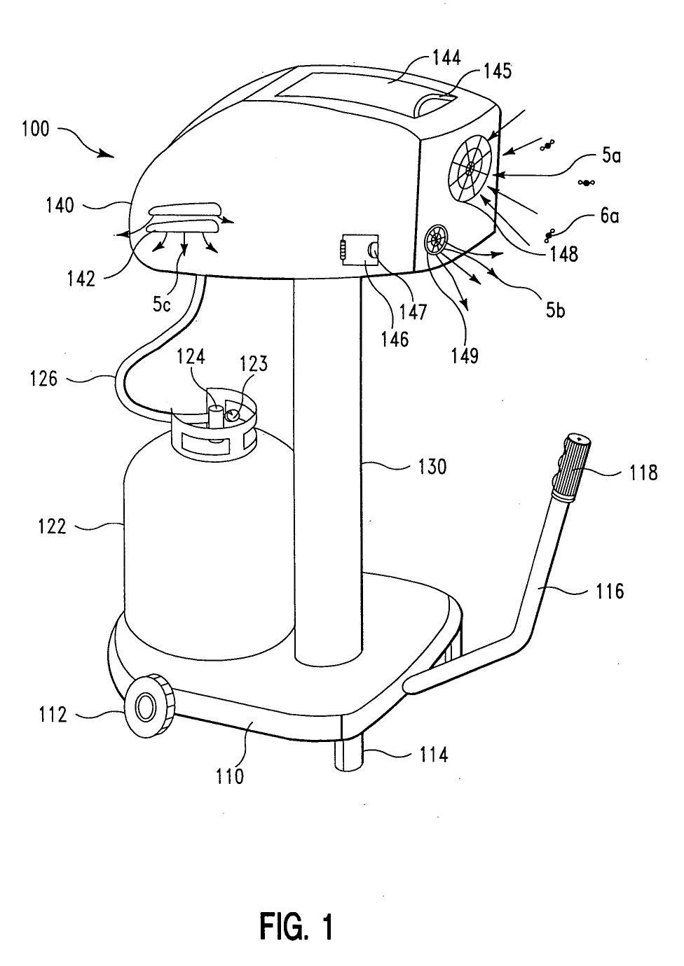

Referring to the drawings, FIG. 1 depicts a perspective view of an embodiment of an insect capturing apparatus 100, in accordance with the present invention. The insect capturing apparatus 100 may have a base 110 for supporting the insect catching apparatus 100. Affixed to the base 110 may be wheels 112 that work in conjunction with at least one foot 114 to provide a sound support for the insect capturing apparatus 100 when positioned in a stationary arrangement. Further affixed to or extending from the base 110 may be a handle 116. The handle 116 may be a single lever arm protruding from the base or may be configured having other shapes such as a U-shaped bar onto which a person may hold the insect capturing apparatus 100 in order to move it. Moreover, the handle 116 may have a grip 118 that may facilitate a firmer gripping handhold of a user who may want to maneuver the insect capturing apparatus 100 to a particular geographic location by rolling it along the wheels 112. The base 110, foot 114, handle 116 and/or grip 118 may be formed of materials such as metals, metal alloys, firm woods, plastics, fiberglass, composite polymeric materials, hard rubber, and/or other like materials and/or combinations thereof.

Referring further to FIG. 1, an embodiment of an insect capturing apparatus 100 may include a fuel container 122. The fuel container 122 may be configured to hold gaseous fuels such as propane, methane, butane, and/or other like gaseous fuels and may accordingly be a canister or tank capable of containing the gaseous fuel. However, embodiments of the insect capturing apparatus 100 may employ different fuel containers 122 that may hold other fuels such as solid fuels like coal, wood, combustible metals, and/or other solid combustive elements, and/or liquid fuels such as gasoline, kerosene, alcohol, and/or other liquid fuels, and/or other materials capable of combusting to produce a heat source. The fuel container may work with a fuel adjustment valve 123 for increasing or decreasing the rate of fuel flow provided to a point of combustion. Moreover, the fuel container 122 and fuel adjustment valve 123 may be coupled together at a fuel container valve interface 124. Furthermore, the insect capturing apparatus may include a fuel conduit 126 for transporting fuel from a fuel container 122 to a point of combustion. Additionally, the insect capturing apparatus 100 may include a support 130, which may be attached to the base 110 and housing 140. The support 130 may be a hollow cylindrical tube providing a rigid structure for supporting the housing 140 and/or other related components. Those skilled in the art should recognize that the geometric configuration of the support 130 may be designed in any shape or way that allows for the support 130 to sustain a durable physical placement of the housing 140.

Referring still further to FIG. 1, an embodiment of an insect capturing apparatus 100 may include a vent 142 located on the housing 140 to facilitate the exiting of a gaseous flow 5c, such as air from the insect capturing apparatus 100. Moreover, the insect capturing apparatus 100 may include a compartment access 144, such as a small hinged door having a compartment access handle 145, which a user may grip to open the compartment access 144 to gain entrance into the housing 140. Further, the insect capturing apparatus may have an optional additive chemical attractant access 146, such as a small hinged panel having a handle 147, which a user may grip to open the optional additive chemical attractant access 146 to insert chemical attractant within the housing 140 of the insect capturing device 100. Further still, the insect capturing device 100 may have an inlet 148 for receiving an entering gaseous flow 5a and through which insects 6a can enter the insect capturing apparatus 100. The inlet 148 may be configured in a circular shape, as shown, or may be configured in any shape that provides for efficient entry of both insects 6a and a gaseous flow 5a into the insect capturing apparatus 100. Furthermore, the size of the inlet 148 may vary according to need for maintaining a gaseous flow 5a and efficiently introducing insects 6a into the insect capturing apparatus 100. In addition, the insect capturing apparatus 100 may include an outlet 149 through which an exiting gaseous flow 5b may pass out of the insect capturing apparatus 100. The size and shape of the outlet 149 may also vary according to need in maintaining an efficient gaseous flow 5b.

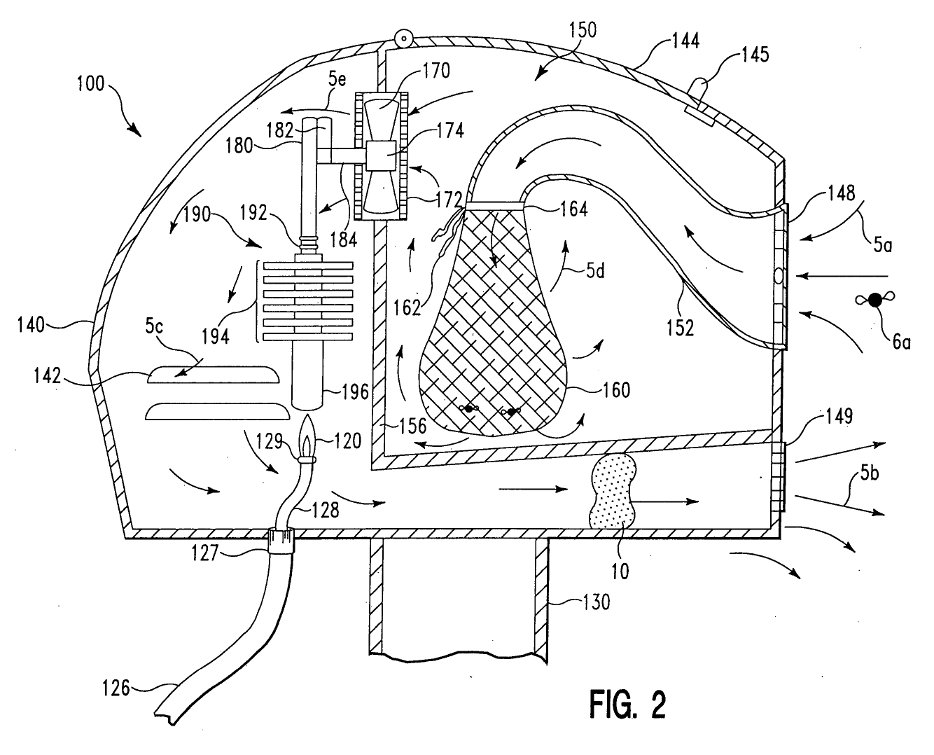

With continued reference to the drawings, FIG. 2 depicts a sectional view of an embodiment of an insect capturing apparatus 100 including a fan 170 powered by a Stirling engine 190, in accordance with the present invention. The insect capturing apparatus 100 may include a heat source 120, such as a flame. The heat source 120, such as a flame, may be sustained by a fuel that promotes chemical combustion releasing heat as a by-product. However, those in the art should recognize that the heat source 120 may be any heat source capable of powering a Stirling engine 190. For example, the heat source 120 may be solar heat from sunlight, wherein the sunlight may be direct, reflected, and/or magnified. Moreover, the heat source may be electrically promoted, such as heat from an electric filament or other like electric heating element, mechanically produced heat, such as friction heat from rubbing mechanical components, biologically produced heat, such as exothermic heat from an organic reaction generated by a biological organism, nuclear produced heat, such as heat spawned from nuclear fission, electromagnetically generated heat, such as heat from lasers, infrared lights, ultraviolet lights, visual white-light sources, x-rays, gamma rays, and/or microwaves, and/or any other like heat source and/or any combination thereof. Further, the heat source 120 may communicate with the Stirling engine 190 through any heat transfer means such as conduction, convection and/or radiation to achieve efficient function of Stirling engine 190.

With further reference to FIG. 2, an embodiment of an insect capturing apparatus 100 may include a fuel conduit 126 attached to a fuel conduit interface 127 coupling the fuel conduit 126 to a housing 140. Extending from the fuel conduit interface 127 may be a heat source placement conduit 128 for locating a heat source 120, such as a flame, proximate a Stirling engine 190. The heat source 120 may emanate from a heat source emission head 129. The insect capturing apparatus 100 may have a support 130 to physically secure the housing 140. Inside the housing 140 may be a compartment 150. The compartment 150 may accommodate an inlet conduit 152 extending from the inlet 148 of housing 140, through which a gaseous flow 5a may pass and an insect 6a may travel. The inlet conduit 152 may be smoothly dimensioned such that the gaseous flow 5a and/or insects 6a are minimally disrupted by the internal geometry of the inlet conduit 152 while passing through the conduit 152. Attached to the inlet conduit 152 may be a receptacle 160, such as a woven bag. The receptacle 160 may be secured to the inlet conduit 152 by a receptacle fastener 162, such as a rope tie, so that the receptacle inlet 164, such as the opening of a woven bag, is in communication with an opening of the inlet conduit 152. Those in the art would appreciate that the receptacle 160 may be any structure through which a gaseous flow 5d may pass, wherein the structure is capable receiving and detaining insects 6b. For example, the receptacle 160 may be a basket-type container having perforations, a bowl-shaped screen, and/or other like vessel that has a receptacle inlet 164, or entry through which a gaseous flow 5a and/or insects 6a may pass into. Moreover, the receptacle inlet 164 may have a compliant lid, trap door, or other physical structure that may assist in preventing insects 6b from escaping the receptacle 160. It should further be recognized that the receptacle fastener 162 may be any implementation, such as a tie, a clip, a hook-and-loop fastener, a button, and/or the like, capable of securing the receptacle 160 in the insect capturing apparatus 100.

With continued reference to FIG. 2, an embodiment of an insect capturing device may include a compartment 150 wherein the compartment 150 is partially enclosed round about by a compartment shell 156. Accordingly, the compartment 150 may be sealed save it be for a closeable compartment access 144 located in the housing 140 and having a handle 145 by which a user may open the access 144 and gain access to the compartment 150, an opening for a fan housing 172 located in a surface of the compartment shell 156, and the receptacle inlet 164 through which a gaseous flow may enter the compartment.

Referring further still to FIG. 2, an embodiment of an insect capturing apparatus 100 may include a fan 170 mounted within a fan housing 172 located in a surface of the compartment shell 156 of compartment 150 included within the insect capturing apparatus 100. The fan 170 may have a drive shaft attachment area 174 where the fan 170 may be attached to a driveshaft 184. The drive shaft 184 may be rotatably affixed to an armature 182, which in turn may be movably affixed to a push rod 180. The push rod 180 may work in conjunction with a piston 192 of a Stirling engine 190. The drive shaft 184 may rotate the fan 170 thereby stimulating a gaseous flow 5e to pass through the fan housing 172 from the compartment 150. Those skilled in the art will recognize that the mechanical components such as the push rod 180, armature 182, and drive shaft 184 may be enhanced by or substituted for various other rods, shafts, linkages, belts, chains, gears, flywheels, and/or other like mechanical elements, and/or combinations thereof capable of turning the fan 170 while working in conjunction with a Stirling engine 190.

In an embodiment of the insect capturing apparatus 100 having a Stirling engine 190, the engine 190 may include a cylinder head 192 and a heat exchanger 194, such as a series of fins for increasing the surface area of a portion of the engine 190. The Stirling engine may use the Stirling cycle. The Stirling cycle utilizes an external heat source, such as heat source 120. A key principle of a Stirling engine 190 is that a fixed amount of gas is sealed, at least temporarily, inside the engine 190. The Stirling cycle involves a series of events that change the pressure of the gas inside the Stirling engine 190 causing it to do work. On a fundamental level, a Stirling engine employs the Stirling cycle to convert heat energy into kinetic energy available to perform work. As embodied in one example, Stirling engine 190 may receive heat externally from heat source 120. The heat may transfer into the expansion chamber 196 of Stirling engine 190 and cause the gas inside the heated chamber 196 to expand. The expanding gas may then work upon a piston or cylinder head 192 causing it to move. The moving piston may be coupled to a push rod 180 that may act with other mechanical components to turn the fan 170. The expanding gas may cool as it expands. Moreover, the push rod 180 may be mechanically configured to move in the opposite/reverse direction as linked to the fan 170 and/or various other mechanical components, such as armature 182 and drive shaft 184 and/or similar components, thereby compressing the expanded gas. As the gas compresses resultant heat energy may dissipate through the heat exchanger 194, such as a series of spaced apart fins. The compressing gas is forced back into the expansion chamber 196 where it quickly heats up, building pressure, at which point the cycle repeats.

The employment of the Stirling cycle to power an embodiment of an insect capturing apparatus 100 may be highly desirable. While it is generally known, by those in the art, that Stirling engines are often less responsive than internal combustion engines or comparable electric motors because the external-to-internal transfer of heat energy associated with the Stirling cycle often makes power cycle increases slow in comparison, and further understood that controllability of cycle time, or rpm output, is often not as manageable when compared with other power sources, it is, however, commonly appreciated that Stirling engines are extremely efficient power producers and very reliable energy converters. Moreover, in an embodiment of an insect capturing apparatus 100, responsiveness and controllability may be of lesser importance than efficiency and reliability. Furthermore, depending on the type of heat source 120 implemented in the insect capturing apparatus 100, possible by-products of heat production, such as CO₂ and/or other chemical emissions and also excess heat may act, as is known in the art, to enhance insect attraction. Hence, while implementation of Stirling cycle heat engines may be viewed as impractical in many commercial applications, utilization of a Stirling cycle heat engine with an embodiment of an insect capturing apparatus 100 may be advantageous.

With still further reference to FIG. 2, an embodiment of an insect capturing apparatus 100 may have an outlet 149. The fan 170, as powered by the Stirling engine may generate a gaseous flow 5e passing from the compartment 150 through the fan housing 172 and into the remaining portion of the housing 140 of the insect capturing apparatus 100. A portion of gaseous flow 5c may exit the housing 140 through vent(s) 142. Additionally, a portion of excess heat emanated from heat source 120 and not utilized by Stirling engine 190 may also exit the housing through the vent(s) 142. The remainder of the gaseous flow 5b may interact with the heat source 120 and pick up, collect, gather, acquire, combine with, and/or merge with the remaining excess heat surrounding and being emitted from the heat source 120 and/or Stirling engine 190. Moreover, the remainder of the gaseous flow 5b may interact with any chemical by-products and/or emissions resulting from heat production and pick up, collect, gather, combine with, and/or merge with the chemical by products. Further, an optional additive chemical attractant 10, such as octenol and/or other like chemical attractants, may be placed in the housing 140, such that the additive chemical attractant 10 is located in the flow-stream of gaseous flow 5b. Hence, the gaseous flow 5b, as merged with excess heat, possible insect attractive chemical by-product emissions, and/or additive chemical attractants, may be emitted from the insect capturing apparatus through outlet 149.

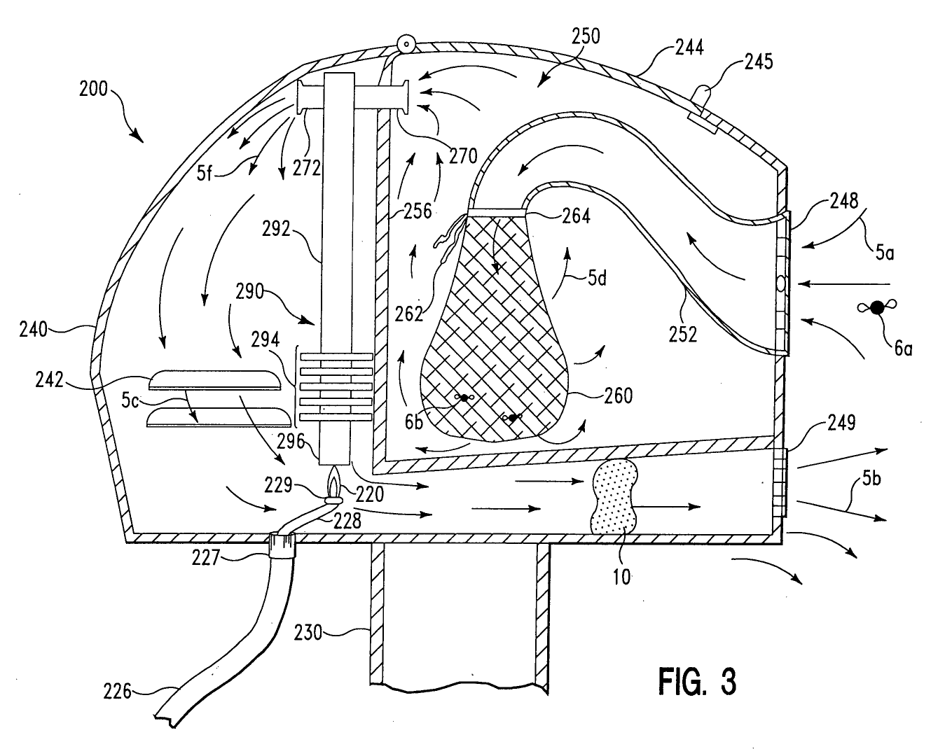

With continued reference to the drawings, FIG. 3 depicts a sectional view of an embodiment of an insect capturing apparatus 200 including a Stirling engine 290 oriented in a vertical position, in accordance with the present invention. The Stirling engine 290 may be an acoustic heat engine relying upon the Stirling cycle and employing fewer moving parts than a mechanically configured heat engine utilizing Stirling cycle energy conversion. For example, the Stirling engine 290 may be a thermal acoustic resonator, pulse tube, or radial wave thermoacoustic engine that converts heat energy into kinetic pressure waves capable of facilitating a gaseous flow, such as gaseous flow 5f. In an embodiment, the Stirling engine 290 may include an acoustic resonation chamber 292, such as a hollow tube, a heat exchanger, such as a set of fins for heat dispersion, and an expansion chamber 296, for increasing the pressure of an enclosed gas. In an embodiment of an insect capturing apparatus 200, the Stirling engine 290 may be physically positioned within the insect capturing apparatus such that the various chambers and components are aligned vertically with the expansion chamber 296 reside at the bottom of the engine 290. The Stirling engine 290 may function in conjunction with a heat source 220 emanating from a heat source emission head 229 as physically oriented by a heat source placement conduit 228. The heat source 220 may be propagated by combustion of a fuel transferred through a fuel conduit 226 as coupled to a housing 240 by a fuel conduit interface 227. However, it is recognized that the heat source 220 may be any supply of heat energy readily available to transfer heat energy to the Stirling engine 290.

Referring further to FIG. 3, the Stirling engine 290 may act to generate a gaseous flow 5f, wherein the flow 5f may be thrust out of an exhaust 272 after being drawn into an intake 270 mounted through a compartment shell 256 and in communication with the Sterling engine 290. Prior to entrance into the intake 270, the gaseous flow 5d inside the compartment 250 may pass through a receptacle 260 having a receptacle inlet 264 through which the flow 5d and/or insects 6d may enter. The receptacle 260 may be removably mounted on an inlet conduit 252 by means of a receptacle fastener 262 and accessed by a user via a compartment access 244 having a handle 245. The gaseous flow 5a and/or insects 6a may enter the inlet conduit 252 via an inlet 248. Once thrust out of exhaust 272, a portion of the gaseous flow 5c may escape the housing 240 through vent(s) 242. The remaining portion of the gaseous flow 5b may interact with the heat source 220 and pick up, collect, gather, acquire, combine with, and/or merge with the remaining excess heat surrounding and being emitted from the heat source 220 and/or Stirling engine 290. Moreover, the remainder of the gaseous flow 5b may interact with any chemical by-product emissions possibly resulting from heat production and pick up, collect, gather, combine with, and/or merge with the chemical by products. Further, an optional additive chemical attractant 10, such as octenol and/or other like chemical attractants, may be placed in the housing 240, such that the additive chemical attractant 10 is located in the flow-stream of gaseous flow 5b. Hence, the gaseous flow 5b, as merged with excess heat, possible insect attractive chemical by-product emissions, and/or additive chemical attractants, may be emitted from the insect capturing apparatus 200 through outlet 249.

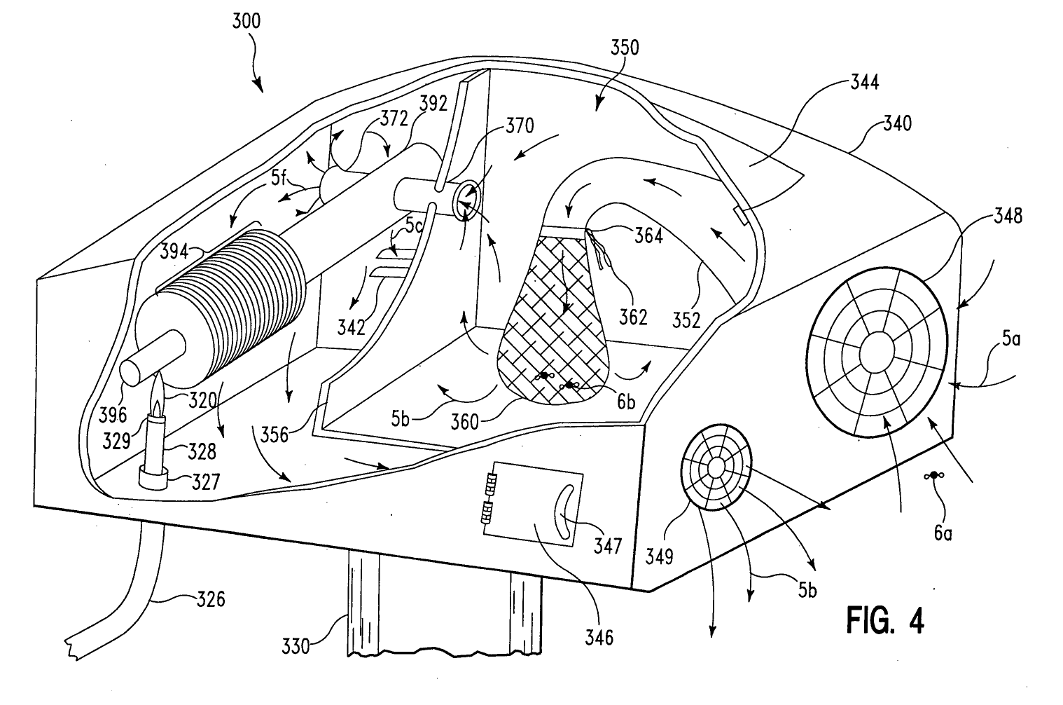

Referring still further to the drawings, FIG. 4 depicts a cut-away perspective view of an embodiment of an insect capturing apparatus 300 including a Stirling engine 390 oriented in a horizontal position, in accordance with the present invention. A heat source 320, such as a flame emanating from a heat source emission head 329 may facilitate external heat energy for interaction and transfer to the Stirling engine 390. Accordingly, the location of initial heat transfer, in this embodiment the geometric proximity of the heat source 320 with the expansion chamber 396, is configured so that the heat source placement conduit 328 may locate the heat source 320 near the expansion chamber 326 of the horizontally positioned Stirling engine 390. Those in the art will recognize that while an acoustic-type heat engine employing the Stirling cycle is embodied as shown in FIG. 4, other embodiments of heat conversion engines using the Stirling cycle may be implemented and used as a Stirling engine 390 power source included as part of the insect capturing apparatus 300. Further, where the heat source 320 is sustained by fuel, an embodiment of the insect capturing apparatus 300 may have a fuel conduit 326 and corresponding fuel conduit interface for connecting the fuel source to a housing 340. The Stirling engine 390 may also incorporate an acoustic resonation chamber 392, such as a hollow pipe, and a heat exchanger, such as fins, a liquid-cooled radiator, and/or other like implement capable of dispersing heat from the Stirling engine 390.

With continued reference to FIG. 4, an embodiment of an insect capturing apparatus 300 may include an inlet 348 for receiving a gaseous flow 5a and through which insects 6a may pass. Further, the insect capturing apparatus 300 may have an inlet conduit 352 attached to an receptacle 360 having an inlet 364 by a receptacle fastener 362. The gaseous flow 5d may seep through the receptacle 360, but insects 6b will remain trapped by, detained, contained, retained and/or permanently hindered within the receptacle 360. By opening the compartment access 340, a user can detach the receptacle 360 and remove any collected insects 6b for proper disposal. The gaseous flow 5d may move within the compartment 350 until it is sucked into the flow intake 370 breaching the compartment shell 356 and blown out of the exhaust 372 and into the remainder of housing 340. Various embodiments of the intake 370 and/or exhaust 372 may utilize check valves or other components the may affect the gaseous flow 5f as generated by Stirling engine 390.

With further reference to FIG. 4, an embodiment of an insect capturing apparatus 300 may include a housing 340 mounted on a support 330. Formed in the housing 340 may be a vent 342. Portions of the gaseous flow 5c may exit the housing 340 through the vent(s) 342 and facilitate dispersion of excess heat dispersed from the Stirling engine 390 or given off by the heat source 320. Moreover, the exiting gaseous flow 5c may carry with it combustion by-products possibly produced by the heat source 320. Also located in the housing surface may be an optional chemical attractant access 346 having a handle 347 allowing a user to place an additive chemical attractant 10 within the housing 340. Gaseous flow 5b may interact with the heat source 320 and pick up, collect, gather, acquire, combine with, and/or merge with the remaining excess heat surrounding and being emitted from the heat source 320 and/or Stirling engine 390. Moreover, the remainder of the gaseous flow 5b may interact with any chemical by-product emissions possibly resulting from heat production and pick up, collect, gather, combine with, and/or merge with the chemical by-products. Further, where the optional additive chemical attractant 10, is placed in the housing 340 such that the additive chemical attractant 10 is located in the flow-stream of gaseous flow 5b, the gaseous flow 5b, as merged with excess heat, possible insect attractive chemical by-products, and/or additive chemical attractants, may be emitted from the insect capturing apparatus 300 through outlet 349.

With continued reference to the drawings, a method of capturing insects is discussed in relation to FIGS. 1-2 and 4. The method may include providing a receptacle 160 having an inlet 164 through which insects 6b can enter into said receptacle 160. The receptacle may be included within an embodiment of an insect capturing apparatus, such as insect capturing apparatus 100 shown in FIGS. 1-2 or insect capturing apparatus 300 shown in FIG. 4 having a receptacle 360. Moreover, the method may include providing insect-attractive chemical emissions. The emissions may be produced by a heat source 120 supplying heat energy to a Stirling engine 190. For example, where a fuel is burned to produce heat, chemical emissions may result as by-products; carbon dioxide may be one such by-product. Those in the art should recognize that carbon dioxide may serve as an insect attractant. In addition, other chemical by-products resulting from external heat source 120 may also act as insect attractants.

Referring still further to FIGS. 1-2 and 4 and with additional reference to FIG. 3, the method for capturing insects may include mixing the insect-attractive chemical emissions produced by heat source 120 (or similar heat source embodiments such as heat source 220 shown in FIG. 3, or heat source 320 shown in FIG. 4, and/or other like heat source elements) with a gaseous flow 5a-f generated by the Stirling engine 190 (or similar Stirling engine embodiments such as Stirling engine 290 shown in FIG. 3, or Stirling engine 390 shown in FIG. 4, and/or other like Stirling engines). The insect capturing apparatus 100 may also emit heat to enhance insect attraction. Accordingly, insects 5a may be attracted to the emissions of chemicals and/or heat. Once near the insect capturing apparatus 100, the insects may be drawn, sucked into the current of a gaseous flow 5a and thereby enter the insect capturing apparatus. The gaseous flow 5a-f, may facilitate detainment of insects 6a within the receptacle 160 (or similar receptacle embodiments such as receptacle 260 shown in FIG. 3, or heat source 360 shown in FIG. 4, and/or other like receptacles). Because the gaseous flow 5d permeates through the receptacle, and/or because the gaseous flow 5a-f flows in one direction, insects may not be able to move against the force and direction of the flow to escape the receptacle 160 of insect capturing apparatus 100. Hence, the insects may be detained within the receptacle 160 until a user accesses the receptacle 160 and detaches the receptacle 160 from the insect capturing apparatus 100 for insect 6b disposal. In this manner the insects may be captured and then properly removed.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

1. An insect capturing apparatus comprising:
a Stirling engine, said Stirling engine configured to convert heat energy directly to kinetic energy for generating a gaseous flow;
a receptacle in communication with said gaseous flow, wherein the receptacle receives insects; and
insect-attractive chemicals, wherein the insect-attractive chemicals are emitted away from the apparatus by said gaseous flow to attract insects to the apparatus.

2. The apparatus of claim 1, wherein the heat energy is supplied by a heat source.

3. The apparatus of claim 2, wherein the heat source is produced by a combusting fuel.

4. The apparatus of claim 2, wherein the heat source produces the insect-attractive chemical emissions.

5. The apparatus of claim 1, wherein the Stirling engine works in conjunction with movable mechanical elements to turn a fan.

6. The apparatus of claim 1, wherein the Stirling engine is an acoustic heat engine utilizing no moving mechanical elements to generate the gaseous flow.

7. An insect capturing apparatus comprising:
a heat source, wherein said heat source produces insect-attractive chemical emissions; and
a Stirling engine, operably associated with said heat source, wherein the Stirling engine directly facilitates the generation of a gaseous flow to detain insects within the apparatus,
wherein the gaseous flow expels the insect-attractive chemical emissions away from the apparatus.

8. The apparatus of claim 7, wherein the heat source is produced by a combusting fuel.

9. The apparatus of claim 7, wherein the Stirling engine works in conjunction with movable mechanical elements to turn a fan.

10. The apparatus of claim 7, wherein the Stirling engine is an acoustic heat engine utilizing no moving mechanical elements to generate the gaseous flow.

11. The apparatus of claim 10 further comprising a receptacle for receiving insects.

12. A method of capturing insects, said method comprising:
providing a receptacle having an inlet through which insects can enter into said receptacle;
providing insect-attractive chemical emissions, said emissions produced by a heat source supplying heat energy to a Stirling engine; and
mixing said insect-attractive chemical emissions with a gaseous flow directly generated by the Stirling engine, said gaseous flow facilitating introduction of insects within said receptacle and conveying said insect-attractive chemical emissions away from the apparatus to attract insects to the apparatus.

13. The method of claim 12, further comprising providing an additive chemical attractant, wherein the additive chemical attractant is mixed with said insect-attractive chemical emissions.

14. The method of claim 12, wherein the Stirling engine is an acoustic heat engine utilizing no moving mechanical elements to generate the gaseous flow.

15. The method of claim 12, wherein the Stirling engine works in conjunction with movable mechanical elements to turn a fan.
